(19) United States
(12) Patent Application Publication
(10) Pub. No.: US 2026/0300144 A1
(43) Pub. Date: Oct. 1, 2026

(54) OVERCOMING CHAINED/RECURSIVE MULTI-FACTOR AUTHENTICATION IN AN AUTOMATED TEST ENVIRONMENT

(71) Applicant: Micro Focus LLC, Wilmington, DE (US)

(72) Inventors: Eyal Jakob, Yehud (IL); Vladyslav Voloshyn, Cumming, GA (US); Constantine Adarchenko, Alpharetta, GA (US)

(73) Assignee: Micro Focus LLC, Wilmington, DE (US)

(21) Appl. No.: 19/095,016

(22) Filed: Mar. 30, 2025

(51) Int. Cl. G06F 11/3668; G06F 21/31

(52) U.S. Cl. CPC G06F 11/3688; G06F 21/31

(57) ABSTRACT

A system, method, and device for handling recursive multi-factor authentication (MFA) in an automated test environment. The method includes sending a first request to authenticate via a first authentication credential provided from a first authentication entity, wherein the first authentication entity requires multi-factor authentication via a second authentication credential provided from a second authentication entity. The method also includes sending a subsequent request to authenticate in a recursive manner, until a final authentication entity is reached that requires a single factor authentication, authenticating with the final authentication entity using credentials for the single factor authentication, and backward propagating each authentication credential from the final authentication entity back to the first authentication entity.

### FIELD

The disclosure relates generally to automated user interface testing and particularly to overcoming chained or recursive multi-factor authentication in an automated testing environment.

### BACKGROUND

In application testing, automating an application login process plays a critical role; without it, application testing would be incomplete, and the test results discovered by the automated testing process would be limited. While in some cases a username/password is sufficient, in many modern web applications multi-factor authentication (MFA) mechanisms are starting to be more commonplace.

MFA augments the standard password with another authentication credential(s), such as, a One-Time Passcode (OTP) sent by Short Message Service (SMS) or email, a fingerprint scan, a faceprint scan, a retinal scan, and/or the like. While this second authentication factor improves security, in many cases, it requires an external entity outside the automated test tool to approve or initiate the login process in order to continue the automated test script. Additionally, the second authentication factor is usually randomly generated and changes each time. This process may be further complicated when the external entity also requires MFA. For example, an email service is used by the application under test as the OTP (e.g., second authentication factor) provider, and the email service itself requires MFA, this is also known as recursive or chained MFA.

### SUMMARY

These and other needs are addressed by the various embodiments and configurations of the present disclosure. The present disclosure can provide a number of advantages depending on the particular configuration. These and other advantages will be apparent from the disclosure contained herein.

To automate the application login process in an application under test (AUT), a web browser may be used to simulate user actions. In many cases, multiple instances of the web browser are used and run in parallel. In many modern web applications multi-factor authentication (MFA) is being used. To overcome MFA in dynamic application security testing the present disclosure runs a multi-stage login flow authenticating against both the authentication service (e.g., an email provider) and the application under test while synchronizing the entire process to prevent the multiple instances of the web browser (executing the login flows) from interfering with each other. The present disclosure is necessarily rooted in computer technology as it overcomes a problem arising in the realm of computer networks (e.g., MFA). The present disclosure allows for automated dynamic application security testing, by avoiding authentication conflicts (e.g., a new request invalidates a previously requested code). The present disclosure synchronizes authentication request for handling in order to avoid conflicts.

There are several existing ways to overcome the recursive MFA problem: 1) Manual intervention; 2) Using an external messaging provider; and 3) Disabling MFA, each of these solutions have their own issues. With manual intervention, during testing, a message requesting the user to enter the factor sent to the external entity would pop up, which requires the user to monitor the test and manually enter the factor. Manual intervention is both slow and not sustainable for long runs. Using an external messaging provider that can receive and extract the additional authentication credential(s) using a dedicated API is problematic for a couple reasons: a) it exposes the authentication credential to an external entity which is less secure (e.g., if an email service is used for MFA, the email service might contain other confidential information together with MFA factor); b) using an external provider introduces the test tool to a dependency on the external provider availability (e.g., an external provider having connectivity issues will cause the test to fail); and c) the external provider might require additional cost to provide the service. Disabling the MFA mechanism for testing purposes is not always feasible and does not simulate a production ready site.

The present disclosure provides a fully automated solution to handle chained or recursive MFA in an automated test environment and supports multiple types of MFA automation (e.g., Time-based One-Time Password (TOTP), One-Time Password/Passcode (OTP), email (Pop3 and IMAP protocols), SMS using external devices, etc.). Modern email service providers may not allow using single factor authentication (e.g., a username & password). Most email service providers require authentication using a pre-defined MFA, which requires an innovative approach to automating the log in process. The solution of the present disclosure consists of a recursive approach to the login process into each MFA provider in a chain (e.g., Outlook, Google, etc.) that itself requires an MFA until a provider in the chain is found that allows a single step or simple form of login (e.g., a username & password). The resulting recursive chain is then played back until the 2FA token is provided to the client application under test.

An automated test script to test an application is started on a first browser. When the automated test script begins user authentication (e.g., enters a critical section), other automated test scripts running on any other browser(s) is paused. In embodiments, each critical section (e.g., where MFA is required) is marked using a script marker, and the paused test scripts are placed into a stack. A first request to authenticate via a first authentication credential provided from a first authentication entity is sent. The first authentication entity also requires multi-factor authentication via a second authentication credential provided from a second authentication entity. Subsequent request to authenticate are sent in a recursive manner, until a final authentication entity is reached that requires a single factor authentication. In embodiments, the authentication requests are placed in a stack. After authenticating with the final authentication entity using credentials for the single factor authentication; each authentication credential is backward propagated from the final authentication entity back to the first authentication entity until the user is logged into the application under test. In embodiments, the top authentication request on the stack is handled and popped off the stack until the stack is empty.

Script markers uniquely identify the MFA provider and MFA credential, so that other tests scripts using the same MFA provider and credential can be identified and paused. In embodiments, script markers may be composite identifiers made up of hashes from the MFA provider and MFA credentials (e.g., email address, phone number, etc.). When execution of a critical section is initiated, the present disclosure checks the execution stack for any existing matching script markers to see if there are other active or pending tasks associated with that script marker. If there are no tasks queued (e.g., stack is empty) for that script marker, the current script marker is added to the stack and executed. However, if another browser accesses the synchronization stack and finds that the script marker is already present (e.g., queued), the current script marker will be added to the stack and will wait its turn to resume execution.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium (e.g., storage system 606) may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably, and include any type of methodology, process, mathematical operation, or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

As described herein and in the claims, the term “browser” may include a plugin to the browser, user interface (UI) automation tool that resides within the browser, and/or the like.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for automatically providing multi-factor authentication in a test environment in accordance with the present disclosure.

FIG. 2A is a flow diagram of a process for automatically providing multi-factor authentication in a test environment in accordance with the present disclosure.

FIG. 2B is a flow diagram of a process for automatically providing recursive multi-factor authentication in a test environment in accordance with the present disclosure.

FIG. 2C is a flow diagram of a process for automatically providing recursive multi-factor authentication in a test environment with multiple users in accordance with the present disclosure.

FIG. 3 is a flow diagram of a method for automatically providing recursive multi-factor authentication in a test environment in accordance with the present disclosure.

FIG. 4 is a process for automatically providing recursive multi-factor authentication for multiple users in a test environment in accordance with the present disclosure.

FIG. 5 is an example MFA workflow that uses an email service as the MFA provider in accordance with the present disclosure.

FIG. 6 is a block diagram illustrating an example computing device for overcoming recursive MFA in automated testing in accordance with the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

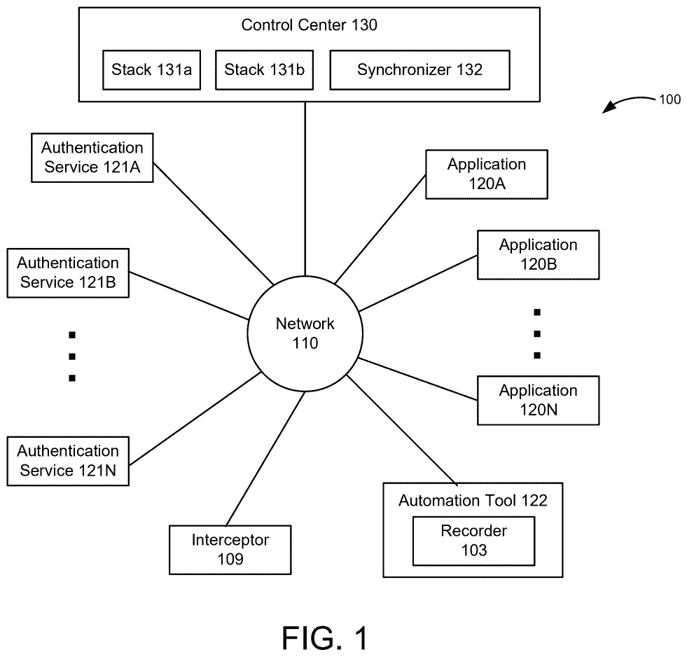

FIG. 1 is a block diagram of a first illustrative system 100 for automatically providing recursive multi-factor authentication (MFA) in a test environment. The first illustrative system 100 comprises an interceptor 109, a network 110, multiple instances of an application 120A-N, which is the application under test, authentication services 121A-N, an automation tool 122, and a control center 130. The automation tool 122 includes a recorder 103. The control center 130 includes a request stack 131a, authentication stack 131b, and a synchronizer 132. In embodiments, the stacks 131a-b are linear data structures where elements are added and removed from the “top” (or end) of the stack (e.g., the last element added is the first one to be removed). Common stack operations include: push (add an element), pop (remove an element), peek (view the top element). In embodiments, the request stack 131a stores paused test scripts and the authentication stack 131b stores each recursive authentication request, once the final authentication entity is authenticated, each element in the authentication stack 131b can be popped off until the authentication stack 131b is empty.

Each application 120A-N may comprise any application, such as, a web application, a social media application, a financial application, a security application, a database, an email application, a human resources application, an online store application, and/or the like. The application under test 120 may include multiple instances of the same application, multiple different applications, or a combination of the multiple instances of the same application and multiple different applications. Each instance of the application 120 may run on a separate browser that is run on the same or separate computing devices, such as a Personal Computer (PC), a telephone, a video system, a cellular telephone, a Personal Digital Assistant (PDA), a tablet device, a notebook device, a smartphone, and/or the like. The browser(s) may be any known browsers, such as, Internet Explorer®, Microsoft Edge®, Google Chrome®, Mozilla Firefox®, Safari®, Opera®, and/or the like. The browser(s) are used to test the application under test 120A-N.

Each authentication service 121 provides additional authentication factor(s) in the authentication process, such as, a SMS authentication process, an email authentication process, a chat authentication process, a question authentication process, a biometric authentication process, and/or the like. The additional authentication factor(s) may be used to log into an email application (e.g., Gmail®, Microsoft Outlook®, Zoho®, ProtonMail®, and/or the like), a text messaging application (e.g., an SMS application, Google Messages, and/or the like), one or more biometric applications (e.g., a fingerprint scanner, a palm scanner, a retinal scanner, a facial scanner, a voiceprint application, and/or the like), etc. The authentication codes for the various types of authentication services 121A-N may be intercepted in various ways, such as, using an interceptor 109, a dedicated Application Programming Interface (API), hooks, network middleware, and/or the like.

The automation tool 122 records tests/authentication processes for testing the application under test 120A-N with the recorder 103. Although shown as part of the automation tool 122, the recorder 103 may be a plugin to the browser(s), may be a standalone application, and/or the like. The recorder 103 may also help manage the multi-factor authentication processes described herein. A test script may be generated from the recording captured by the recorder 103. For example, a user's operations are recorded and the recording is processed to generate a test script (e.g., each user operation is translated into a command). The automation tool 122 may also process the generated test script to identify and mark when the test scripts enters an authentication workflow (e.g., a critical section). In embodiments, an MFA workflow is identified based on network activity, DOM inspection, and/or the like. Each MFA workflow may be broken into its own macro and the macros may be chained together as a single script used for the login process.

Upon running the generated test script, the UI Automation tool 122 will execute each MFA workflow, in which the automation tool 122 needs to wait until each additional authentication factor is provided to continue to the next step in the test script. For example, for every link in the MFA chain the execution would be as follows: the UI Automation tool 122 will repeat the user operations except for the MFA flow, since MFA is randomly generated, providing the same input entered while recording the script will fail the execution flow. Therefore, the Automation tool 122 will execute the script up until an MFA flow. Once the automation tool 122 arrives at an MFA script marker, it will treat it as access to a shared resource (eventually the MFA provider) in which running the MFA requires authorization before entering; it will communicate with the control center 130 asking to start MFA authentication flow and wait for response. The request may contain additional details allowing the control center 130 to return to the automation tool 122 with information about its request (e.g., details such as client ID, max time to satisfy the request, etc.). Once the automation tool 122 receives information from the control center 130, depending on the result (authentication success, additional authorization required, authentication failure) it will resume to execute the next script steps. In case of authentication success for the final link in the chain, the result will contain the MFA factor that is required to proceed the MFA workflow for the previous link in the chain, recursing back until the last MFA factor is provided to the application under test 120.

The interceptor 109 is an application that is used to intercept authentication codes, biometric information, and other authentication information sent from the authentication services 121A-N. The interceptor 109 extracts the MFA factor and sends the information to the control center 130.

The network 110 can be or may include any collection of communication equipment that can send and receive electronic communications, such as the Internet, a Wide Area Network (WAN), a Local Area Network (LAN), a packet switched network, a circuit switched network, a cellular network, a combination of these, and the like. The network 110 can use a variety of electronic protocols, such as Ethernet, Internet Protocol (IP), Hyper Text Markup Language (HTML), Hyper Text Transfer Protocol (HTTP), Web Real-Time Protocol (Web RTC), and/or the like. Thus, the network 110 is an electronic communication network configured to carry messages via packets and/or circuit switched communications.

The control center 130 can be or may include any hardware coupled with software that can be used to automate a recursive multi-factor authentication process for testing the application under test 120. The control center 130 may be a separate communication device, a separate application (e.g., a separate process on a different thread/core), and/or the like. The control center 130 further comprises a request stack(s) 131 and a synchronizer 132. The control center 130 coordinates between the automation tool 122 and each authentication service 121A-N. When a request from the automation tool 122 is sent, the control center 130 adds the request to the stack 131, in case the stack 131 is empty, the control center 130 will “release” the automation tool 122 to perform its next steps. Once a message arrives from the authentication service 121A-N, the control center 130 will pull the top entity from the stack 131, send the MFA factor including additional information (if such required) back to the automation tool 122 (e.g., requesting entity), and move to the next entity in the pending stack. In recursive or chained MFA, every link in the chain communicates with the control center 130 to ensure coordination for all the links in the chain. The MFA chain should not be broken (meaning, no chains can be run in parallel when the script is replayed).

The request stack(s) 131 are used for queuing requests to authenticate a user. The automation tool 122 may have one or more outstanding authentication requests. For example, an authentication request may be stored in the request stack 131 until an authentication code has been provided to the application under test 120.

The synchronizer 132 can be or may include any hardware coupled with software that can manage and synchronize the authentication process. In one embodiment, the synchronizer 132 manages and synchronizes the authentication process via the request stack(s) 131. The synchronizer 132 may synchronize multiple authentication credentials required for the same user and/or for multiple users.

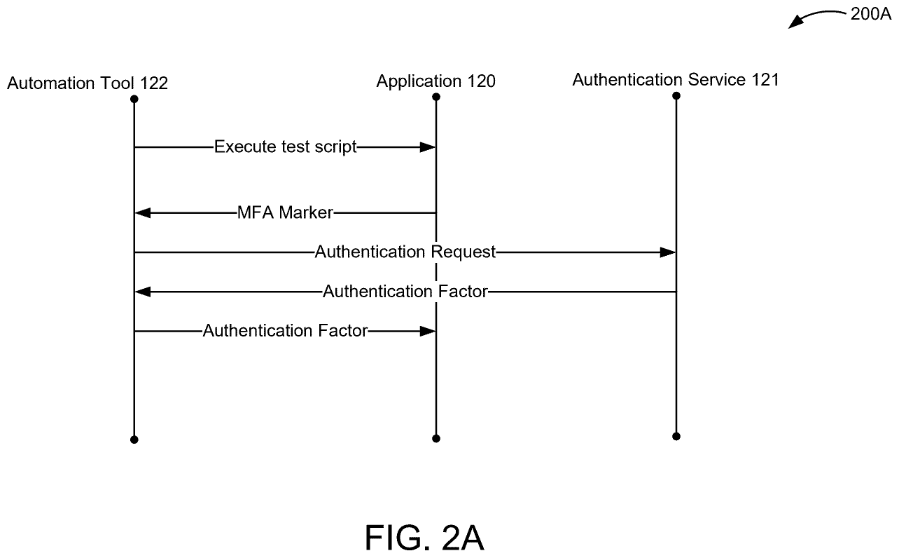

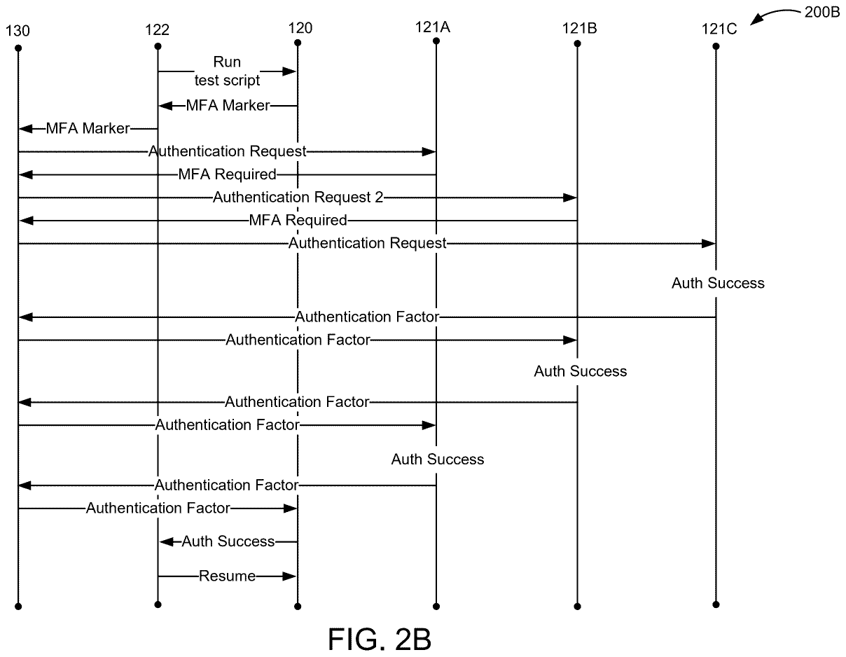

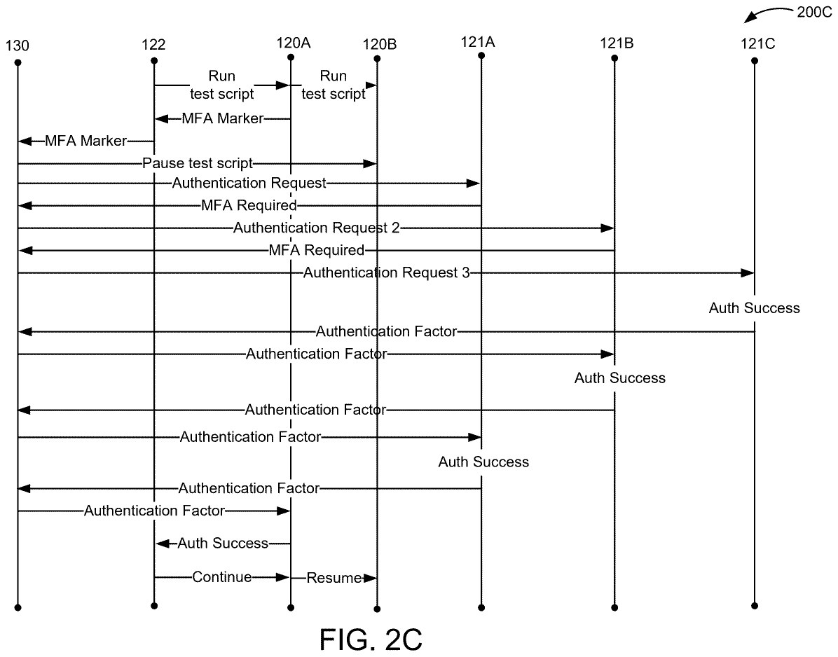

Referring to FIGS. 2A-C, various MFA workflows are illustrated. Illustratively, the steps in FIGS. 2A-C may be performed by executing program instructions stored in a computer readable storage medium, such as a memory (i.e., a computer memory, a hard disk, and/or the like). Although the workflows described in FIGS. 2A-C are shown in a specific order, one of skill in the art would recognize that the steps in FIGS. 2A-C may be implemented in different orders and/or be implemented in a multi-threaded environment. Moreover, various steps may be omitted or added based on implementation.

The workflows of FIGS. 2A-C may be used in conjunction with the first illustrative system 100 of FIG. 1 and/or other similar test environments.

In FIG. 2A the workflow 200A starts with execution of a test script. The test script may be generated when the recorder 103 records a testing session of an application under test 120. The testing session may include various types of tests to test the application under test 120, such as, security testing, user interface testing, implementation testing, usability testing, and/or the like. The recorded testing session typically includes testing the authentication process, which may include multi-factor authentication. The authentication process typically includes one or more authentication credentials, such as, a username/password, a SMS code, an email code, a chat code, a biometric scan (e.g., a fingerprint scan, a facial print scan, an iris scan, a palm print scan, a voiceprint, etc.), a combination of these, and/or the like. Where more than one authentication credential is used (e.g., a multi-factor authentication), at least one of the authentication credentials is sent to or comes from the authentication service 121. For example, an SMS code may be sent to a phone number, an email code may be sent to the user's email address, a fingerprint scan may be received from the user's smartphone 105, and/or the like.

For authentication credentials that are static and do not require authentication service 121 (e.g., a username/password), it is easy to record the username/password and then playback the username/password to authenticate the user. However, for authentication credentials where an authentication service 121 is required or a dynamic authentication code is required, the process is much more difficult to automate.

To rerun the recorded tests, the automation tool 122 plays back the recorded session up to the required authentication process where an additional authentication factor is required. The section of the test script for the MFA authentication process is marked with an MFA marker. This step can be identified based on text recognition, window recognition, user intervention, and/or the like. If the authentication process first requires a username/password and then a second authentication factor, the automation tool 122 plays back the recorded session up to where the second authentication factor is required. Instead of sending a request to authenticate to the application under test, the automation tool 122 sends, a second authentication request to the authentication service 121 (e.g., a request for an SMS code). The authentication service 121 provides the second authentication factor to the automation tool 122, which uses the second authentication factor to complete login to the application 120 under test. In embodiments, a control center 130 (not shown) receives and stacks the authentication requests for handling.

In FIG. 2B, a recursive MFA workflow 200B is illustrated. For example, we need to login into the application 120 under test (e.g., customerapp.com) that requires an email MFA from an email service (e.g., outlook.com), when logging into outlook.com it requires an MFA (e.g., a TOTP).

To rerun the recorded tests, the automation tool 122 plays back the recorded session up to the required authentication process where an additional authentication factor is required. The section of the test script for the MFA authentication process is marked with an MFA marker. This step can be identified based on text recognition, window recognition, user intervention, and/or the like. Instead of sending a request to authenticate to the application under test, the automation tool 122 sends, a second authentication request to the control center 130, which places the request to authenticate in the request stack 131, this is done recursively until authentication is permitted, and an authentication success message is sent to the control center 130 along with the additional authentication factor. Each additional authentication factor is back propagated through the request stack 131 until the request to authenticate from the application under test 120 is completed and the test script may resume.

FIG. 2C illustrates a multi-user recursive MFA workflow 200C registering multiple users with shared MFA providers. The process of FIG. 2B will be repeated for multiple requests to authenticate. For example, there may be multiple requests to authenticate received from multiple browsers running the same or different test scripts. In FIG. 2C, when one browser executing a test script on an application (e.g., 120A) enters a critical section (e.g., user authentication), any other browsers that require MFA synchronization will be paused. MFA synchronization is required when the same MFA provider and MFA credentials are used (e.g., email is the MFA provider using the same email). For example, if there is an authentication constraint between browser A and browser B (e.g., a token sent to the same email or browsers running the same test script) that will require MFA synchronization. In another example: Browser C running a test on application A uses server C to get the token, and browser D running a test on application B uses server D to get the token, so different servers generate different tokens and the tokens do not override each other and it may not be mandatory to synchronize the authentications of browsers C and D even though the same email is used for both applications. In other words, authentication synchronization is mandatory to avoid the case when generating a token makes the previous one obsolete. Thus resolving the complexity of synchronizing between multiple logins running at the same time, using a different/same credential(s) and a shared MFA provider (phone/email). Note: the providers in the MFA chain need to be different to avoid deadlocks.

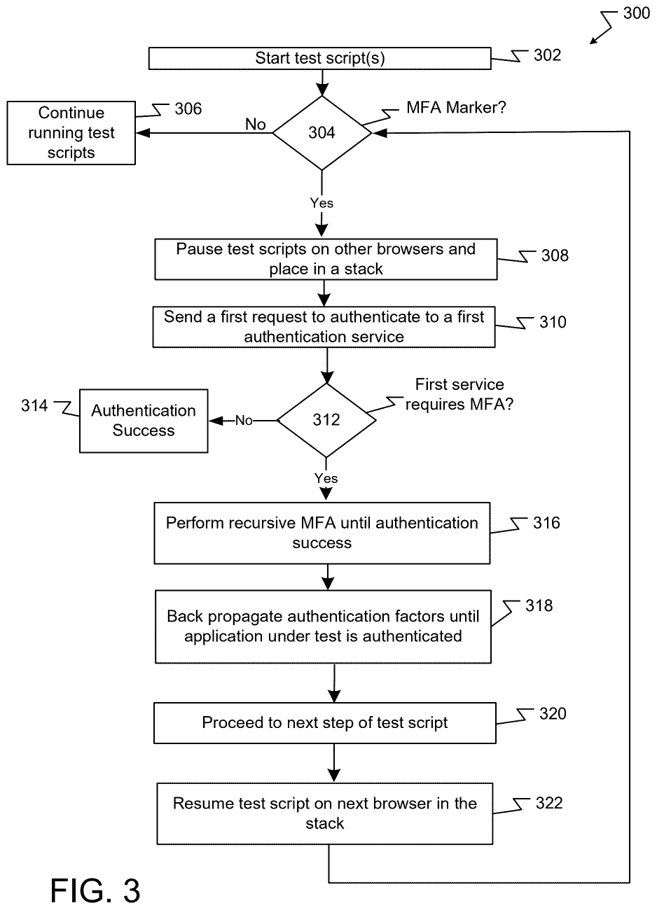

FIG. 3 depicts a method 300 that may be used, for example, for performing recursive multi-factor authentication in an automated test environment (e.g., illustrative system 100).

The method 300 (and/or one or more steps thereof) may be carried out or otherwise performed, for example, by at least one processor. The at least one processor may be the same as or similar to the processing system 603 of the computing device 600 described below. The processing system 603 may perform the method 300 by executing elements stored in a memory such as in the storage system 606. The elements stored in memory and executed by the processor may cause the processor to execute one or more steps of a function as shown in method 300. One or more portions of a method 300 may be performed by the processor executing any of the contents of memory, such as automation tool 622, control center 630 and MFA provider 609.

The method 300 comprises starting an automated test script on at least one browser (step 302). For example, the automated test script may be to test an application 120. The test script(s) run until an MFA marker is detected (step 304). If no MFA marker is detected (step 304 no), the test script(s) continue to run (step 306). Once an MFA marker is detected (step 304 yes), any test script(s) using the same MFA provider/credentials are paused and placed into a stack (e.g., the stack 131a) (step 308). A first request to authenticate via a first authentication credential provided from a first authentication entity is sent (step 310). If the first entity does not require MFA (step 312 no), then the application under test is successfully authenticated (step 314). If the first entity does require MFA (step 312 yes), the recursive MFA is performed until authentication success (step 316). In other words, subsequent requests to authenticate are sent in a recursive manner (e.g., the authentication stack 131b), until a final authentication entity is reached that requires a single-factor authentication, and using credentials for the single-factor authentication the final authentication entity is successfully authenticated or MFA that does not require additional chain such (e.g. TOTP). After the final authentication entity is successfully authenticated, each authentication credential is backward propagated from the final authentication entity back to the first authentication entity (step 318). Once the recursive authentication successfully authenticates on the active browser the test script continues to the next step (step 320), and test script on the next browser in the stack is resumed (step 322). The method 300 ends once the stack is empty.

The present disclosure encompasses embodiments of the method 300 that comprise more or fewer steps than those described above, and/or one or more steps that are different than the steps described above.

As noted above, the present disclosure encompasses methods with fewer than all of the steps identified in FIG. 3 (and the corresponding description of the method 300), as well as methods that include additional steps beyond those identified in FIG. 3 (and the corresponding description of the method 300). The present disclosure also encompasses methods that comprise one or more steps from one method described herein, and one or more steps from another method described herein.

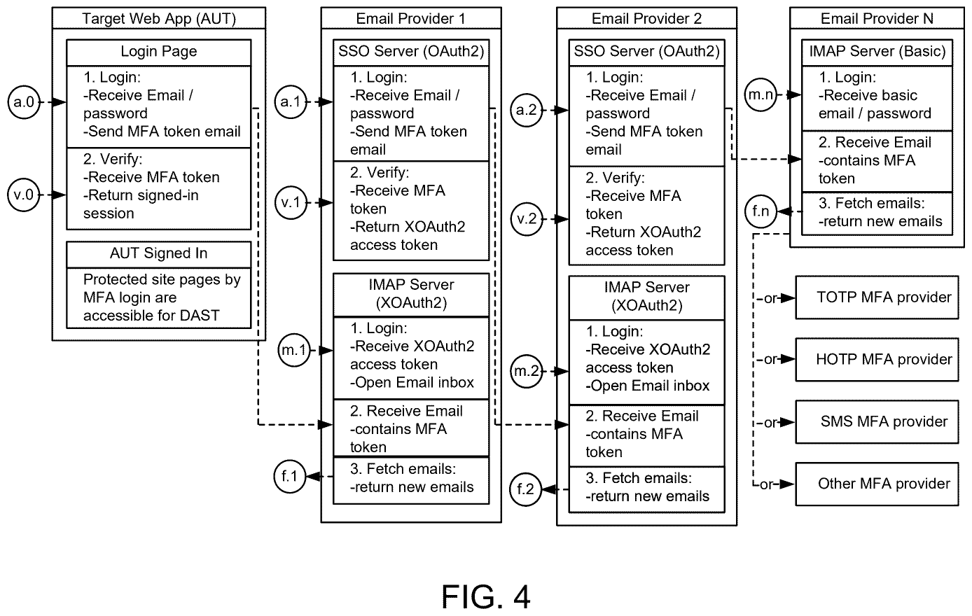

FIG. 4 is a process for automatically providing recursive multi-factor authentication for multiple users in a test environment.

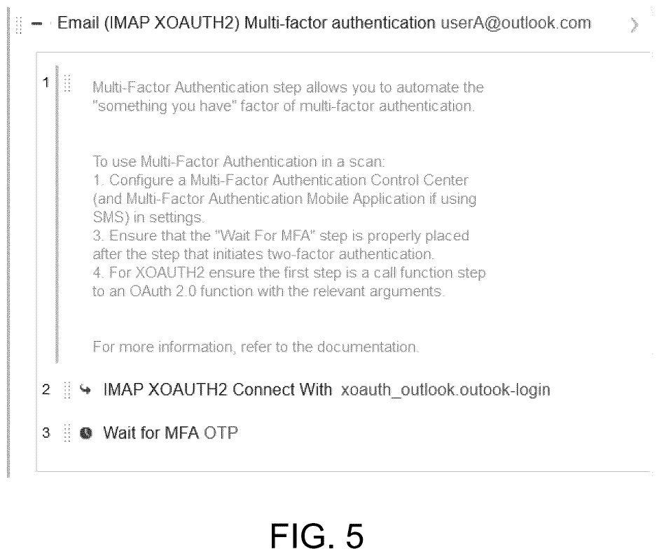

FIG. 5 is an example MFA workflow that uses an email service as the MFA provider.

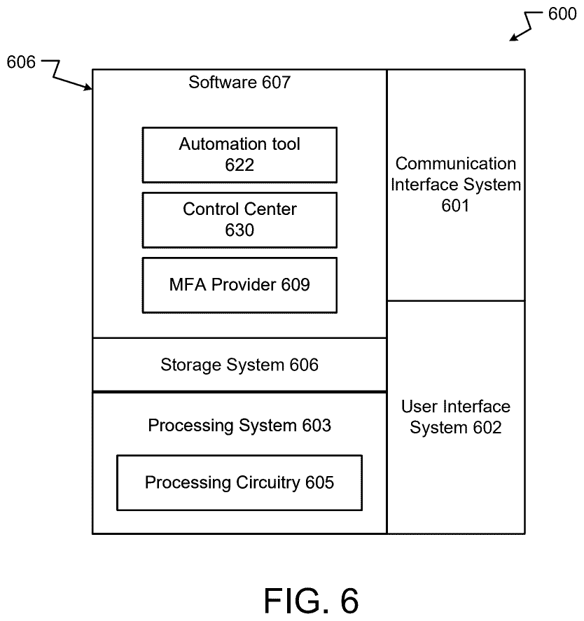

FIG. 6 depicts a computing device 600 in accordance with embodiments of the present disclosure. The computing device 600 handles recursive MFA in an automated test environment in accordance with the embodiments disclosed herein.

A computing device 600 is representative of any computing system or systems with which the various operational architectures, processes, scenarios, and sequences disclosed herein to [ ] comprising various components and connections to other components and/or systems.

The computing device 600 comprises a communication interface system 601, a user interface system 602, and a processing system 603. The processing system 603 is linked to the communication interface system 601 and user interface system 602. The processing system 603 includes a microprocessor and/or processing circuitry 605 and a storage system 606 that stores operating software 607. The computing device 600 may include other well-known components such as a battery and enclosure that are not shown for clarity. The computing device 600 may comprise a server, a user device, a desktop computer, a laptop computer, a tablet computing device, or some other user communication apparatus.

The communication interface system 601 comprises components that communicate over communication links, such as network cards, ports, radio frequency (RF), processing circuitry and software, or some other communication device. Communication interface system 601 may be configured to communicate over metallic, wireless, or optical links. Communication interface system 601 may be configured to use Time Division Multiplex (TDM), Internet Protocol (IP), Ethernet, optical networking, wireless protocols, communication signaling, or some other communication format, including combinations thereof. In some implementations, the communication interface system 601 is configured to communicate with other devices, wherein the communication interface system 601 is used to retrieve screen size and webpage layout data.

The user interface system 602 comprises components that interact with a user to display a rendered webpage and/or alerts and receive input from the user. The user interface system 602 may include a speaker, microphone, buttons, lights, display screen, touch screen, touch pad, scroll wheel, communication port, or some other user input/output apparatus, including combinations thereof.

The processing circuitry 605 may be embodied as a single electronic microprocessor or multiprocessor device (e.g., multicore) having therein components such as control unit(s), input/output unit(s), arithmetic logic unit(s), register(s), primary memory, and/or other components that access information (e.g., data, instructions, etc.). The processing circuitry 605 may receive instructions (e.g., via a bus), executes the instructions, and outputs data (e.g., via the bus). In other embodiments, the processing circuitry 605 may comprise a shared processing device that may be utilized by other processes and/or process owners, such as in a processing array or distributed processing system (e.g., “cloud,” farm, etc.). It should be appreciated that the processing circuitry 605 is a non-transitory computing device (e.g., an electronic machine comprising circuitry and connections to communicate with other components and devices). The processing circuitry 605 may operate a virtual processor, such as to process machine instructions not native to the processor (e.g., translate the Intel® 9xx chipset code to emulate a different processor's chipset or a non-native operating system, such as a VAX operating system on a Mac). However, such virtual processors are applications executed by the underlying processor and the hardware and other circuitry thereof.

The processing circuitry 605 comprises a microprocessor and other circuitry that retrieves and executes the operating software 607 from the storage system 606. The storage system 606 may include volatile and nonvolatile and removable and non-removable media implemented in any method or technology for storage of information, such as computer readable instructions, data structures, program modules, or other data. The storage system 606 may be implemented as a single storage device, but may also be implemented across multiple storage devices or sub-systems. The storage system 606 may comprise additional elements, such as a controller to read the operating software 607. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. It should be understood that in no case is the storage media a propagated signal.

The processing circuitry 605 is typically mounted on a circuit board that may also hold the storage system 606 and portions of the communication interface system 601 and the user interface system 602. The operating software 607 comprises computer programs, firmware, or some other form of machine-readable program instructions. The operating software 607 includes automation tool 622, control center 630, and MFA provider 609, although any number of software modules within the application may provide the same operation. The operating software 607 may further include an operating system, utilities, drivers, network interfaces, applications, or some other type of software. When executed by the processing circuitry 605, the operating software 607 directs the processing system 603 to operate the computing device 600 as described herein.

In at least one implementation, the automation tool 622, when read and executed by the processing system 603, directs the processing system 603 to perform automated testing of an application. The control center 630, when read and executed by the processing system 603, directs the processing system 603 to synchronize recursive MFA. MFA provider 609, when read and executed by the processing system 603, directs the processing system 603 to intercept and/or extract each additional authentication factor for each MFA request in an MFA chain.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22nm Haswell, Intel® Core® i5-3570K 22nm Ivy Bridge, the AMD® FX™ family of processors, AMD® FX-4300, FX-6300, and FX-8350 32nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits several known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated that the components of the system can be combined into one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users'premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that are capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that, when executed by the microprocessor, cause the microprocessor to:
start an automated test script on a first browser, wherein the automated test script tests an application;
enter a critical section of the automated test script, wherein the critical section of the automated test script comprises user authentication;
while the automated test script on the first browser is in the critical section, pause the automated test script running on any other browser, wherein each automated test script on each browser is placed into a stack;
send a first request to authenticate via a first authentication credential provided from a first authentication entity, wherein the first authentication entity requires multi-factor authentication via a second authentication credential provided from a second authentication entity;
send a subsequent request to authenticate in a recursive manner, until a final authentication entity is reached that requires a single-factor authentication;
authenticate with the final authentication entity using credentials for the single-factor authentication; and
backward propagate each authentication credential from the final authentication entity back to the first authentication entity.

2. The system of claim 1, wherein the microprocessor readable and executable instructions further cause the microprocessor to:
resume a next test script in the stack.

3. The system of claim 1, wherein the single-factor authentication comprises a username/password combination.

4. The system of claim 1, wherein the stack comprises a last-in-first-out (LIFO) stack.

5. The system of claim 1, wherein the first authentication entity comprises a mail server.

6. The system of claim 1, wherein the first authentication credential is a Short Message Service (SMS) code.

7. The system of claim 1, wherein the first authentication credential is a chat code.

8. The system of claim 1, wherein the first authentication credential is an email code.

9. The system of claim 1, wherein the first authentication credential is a biometric identifier.

10. A method comprising:
starting an automated test script on a first browser, wherein the automated test script tests an application;
entering a critical section of the automated test script on the first browser, wherein the critical section of the automated test script comprises user authentication;
while the automated test script on the first browser is in the critical section, pausing the automated test script running on any other browser, wherein each automated test script on each browser is placed into a stack;
sending a first request to authenticate via a first authentication credential provided from a first authentication entity, wherein the first authentication entity requires multi-factor authentication via a second authentication credential provided from a second authentication entity;
sending a subsequent request to authenticate in a recursive manner, until a final authentication entity is reached that requires a single-factor authentication;
authenticating with the final authentication entity using credentials for the single-factor authentication; and
backward propagating each authentication credential from the final authentication entity back to the first authentication entity.

11. The method of claim 10, further comprising:
resuming a next test script in the stack.

12. The method of claim 10, wherein the single-factor authentication comprises a username/password combination.

13. The method of claim 10, wherein the stack comprises a last-in-first-out (LIFO) stack.

14. The method of claim 10, wherein the first authentication entity comprises a mail server.

15. The method of claim 10, wherein the first authentication credential is a Short Message Service (SMS) code.

16. The method of claim 10, wherein the first authentication credential is a chat code.

17. The method of claim 10, wherein the first authentication credential is an email code.

18. The method of claim 10, wherein the first authentication credential is a biometric identifier.

19. A system comprising:
a microprocessor; and
a computer readable medium, coupled with the microprocessor and comprising microprocessor readable and executable instructions that, when executed by the microprocessor, cause the microprocessor to:
start a process to wait for an authentication credential, wherein the authentication credential is received as part of an automated multi-factor authentication process and wherein the authentication credential is received from an external communication device;
receive, from the external communication device, the authentication credential;
send the authentication credential to an application under test;
receive an acknowledgement of receipt of the authentication credential; and
in response to receiving the acknowledgement of the receipt of the authentication credential, automatically run one or more recorded tests of the application under test.

20. The system of claim 19, wherein the authentication credential comprises one of: a Short Message Service (SMS) code, a chat code, an email code, or a biometric identifier.
